(19) United States
(12) Patent Application Publication
(10) Pub. No.: US 2019/0363547 A1
(43) Pub. Date: Nov. 28, 2019

(54) A Charger For Adaptive Battery Charging And Methods Of Use

(71) Applicant: Humavox Ltd., Raanana (IL)

(72) Inventor: Oded Golan, Tel Aviv (IL)

(21) Appl. No.: 16/467,649

(22) PCT Filed: Dec. 7, 2017
(86) PCT No.: PCT/IL2017/051329

§ 371 Date: Jun. 7, 2019

Related U.S. Application Data
(60) Provisional application No. 62/431,447, filed on Dec. 8, 2016.

(51) Int. Cl. H02J 7/00; H01M 10/44; H01M 10/48; H02J 7/02

(52) U.S. Cl. CPC H02J 7/007; H01M 10/443; H02J 7/025; H02J 7/0042; H01M 10/486

(57) ABSTRACT

This invention is directed to a method for charging a rechargeable battery in a dynamic adaptive current charging profile at a maximal available current value to allow improved charging efficiency and to minimize heat production during charging relative to constant current charging profile. The invention is further directed to a charger configured to charge a battery in an adaptive charging current profile and to a system for adaptive current charging.

### TECHNOLOGICAL FIELD

The invention is related to a novel charger and to a method for charging a battery that allows improved charging process of electronic devices in general, and to adaptive current charging profile of batteries that allows minimal heat production during charging, in particular.

### BACKGROUND

In today's world when electronic devices, especial wearable electronic devices operated by rechargeable Lithium batteries become smaller every day, the heat generated by the charging process becomes a significant problem.

Traditional charging of Lithium-Ion batteries generally consists of three charging phases: pre-charge; fast-charge constant current (CC); and constant voltage (CV) termination.

In the pre-charge phase, the battery is charged at a low-rate (typical of 1/10 the fast charge rate) when the battery cell voltage is below 3.0 V. This provides recovery of the passivating layer which might be dissolved after prolonged storage in deep discharge state. It also prevents overheating at 1 C charge when partial copper decomposition appears on anode-shorted cells on over-discharge. When the battery cell voltage reaches 3.0 V, the charger enters to the CC phase.

In the Constant Current (CC) phase, the battery is charged in constant current till it reaches the required voltage. In this phase the battery is charged to around 70% to 80% of its capacity. Charge rate is often denoted as C or C-rate and signifies a charge or discharge rate equal to the capacity of a battery in one hour. The charging current used influence the battery longevity. The charging current doesn't have to be accurate and a variation of +/−20% is acceptable.

In the Constant Voltage (CV) phase, the requirement is that the battery voltage will not pass the predefined limit. Achieving the requirement is done by controlling (reducing) the current. Accuracy is very important at this stage.

Detailed description of the charging phases is described in: http://www.eetimes.com/document.asp?doc_id=1273031&page_number=1

The main problem with the charging methodology described above is that the charging process is very sensitive to temperature, and the battery should not be charged above a certain temperature. Excessive temperature rise in lithium-chemistry cell packs has always been a major design issue, as most Li-ion cells must not be charged above 45° C. or discharged above 60° C. These limits can be pushed a bit higher, but at the expense of cycle life (http://electronicdesign.com/boards/keep-eye-temperature-trends-during-li-ion-battery-charge-and-discharge-cycles).

Chargers available in the market are configured to charge at a preprogrammed current during Constant Current (CC) phase and limit the current at the Constant Voltage (CV) according to the battery voltage. When the battery reaches the upper temperature allowed the charger either reduces the current or stops charging.

Thus, there is a need in the art for improved charging process for electronic devices that minimize the creation of heat.

Several attempts were made in the art to improve the charging process. Some of them are described in the following patents and patent application: WO 2015199995; U.S. Pat. Nos. 8,624,560; 9,559,543; 8,841,884; 8,754,614. The common denominator to all of these patents and patent applications, as well as to others trying to improve the charging process, is that they try to improve the components and/or the features of the battery, but still remain at the common charging phases of constant current and constant voltage. The present invention is a conceptual breakthrough as it challenges the traditional charging phat from an energy point of view and can be implemented in the above suggested solutions to further improve the charging process by changing the constant current charging phase to be an adaptive current charging phase, as will be described in details hereinbelow.

### SUMMARY OF THE INVENTION

The present invention is one main aspect is aimed to improve the charging process of batteries by converting the constant current charging phase (CC) of the common charging protocol to be an adaptive current charging phase, in a manner that charging at this phase is not performed with a constant, fixed current value, but rather, it changes during the charging process according to values that are being measured on the charging circuit, for example (Vin), and on the charged battery for example, (Vbat, I charge) in real time. By adapting the charging current values, according to real time measured values, the charging process becomes more accurate and the heat produced during this charging phase is reduced relative to charging by constant current values.

In another main aspect, this invention is aimed to provide a charger, configured to charge a battery in a dynamic manner with adaptive current charging values that are based on real time monitoring of various indicative parameters as will be described in the detailed description hereinbelow.

In one main aspect, the present invention is directed to a method for charging a rechargeable battery, said method comprising: (a) charging the battery in a pre-charging profile up to a minimal voltage value; (b) charging the battery in dynamic adaptive current charging profile at a maximal available current value; and (c) charging the battery in a constant voltage profile up to termination of charging; wherein, the dynamic adaptive current charging profile at a maximal available current is configured to allow improved charging efficiency and to minimize heat production during charging relative to constant current charging profile. The maximal available current value at the adaptive current charging profile is determined by a charger (PMIC) connected to the battery. The charger determines the maximal available current value at a specific time point based on measured parameters in real time. The measured parameters may be at least one of the following parameters: battery temperature, battery's surroundings temperature, battery voltage level, battery charge current, a rectifier connected to the charger voltage, and a rectifier connected to the charger current. As the measured parameters are indicative of the charging level of the battery it allows the charger to adjust the charging current at step (b) of the charging method accordingly. The measured parameters are further indicative of the safe charging range of the battery for maintaining longevity of battery.

In some embodiments, the charger is configured to allow charging at maximal available charging current in real time by controlling an adaptive impedance network connected thereto and/or by an internal PWM according to the at least one of the measured parameters. It should be clear that the maximal available current value is the maximal current that can be obtained by a receiving unit connected to the battery from a transmitted energy either wirelessly or none wirelessly.

In some embodiment of the invention, the charger communicates the measured parameters values to a transmitting unit, the transmitting unit is configured to control the charging process by modifying the RF power level transmitted toward a receiving unit connected to said battery at a certain time point according to the values received from the charger.

In all aspects mentioned above, the charging process is performed within a safe predefined range of temperature, voltage and current so as to maintain longevity of the charged battery and avoid damage that may occur to the battery or shorten the battery. As mentioned above, the charging process in accordance with embodiments of the invention may be a wireless charging or a none-wireless charging process.

In one further aspect of the invention, a charger (PMIC) configured to charge a rechargeable battery in a dynamic adaptive current charging profile at a maximal available current value is provided, wherein the charger is connected to a rechargeable battery and to a receiving unit having an impedance matching network, and wherein said dynamic adaptive current charging profile at a maximal available current is configured to allow improved charging efficiency and to minimize heat production during charging relative to constant current charging profile. In such embodiment, the maximal available current value at the adaptive current charging profile is determined by the charger at a specific time point based on measured parameters in real time. The measured parameters are at least one of the following parameters: battery temperature, battery's surroundings temperature, battery voltage level, battery charge current, a rectifier connected to the charger voltage, and a rectifier connected to the charger current. The measured parameters are indicative of the charging level of the rechargeable battery and allow the charger to adjust the charging current value to minimize heat production. The measured parameters are further indicative of the safe charging range of the battery for maintaining longevity of battery.

In accordance with embodiments of the invention, the charger is configured to allow charging at maximal available charging current in real time by controlling an adaptive impedance network connected thereto and/or an internal PWM according to the at least one measured parameters. The maximal available current value is the maximal current that can be obtained by a receiving unit connected to the rechargeable battery from a transmitted energy.

In some further embodiments, the charger may communicate the measured parameters values to a transmitting unit, said transmitting unit is configured to control the charging process by modifying the power level transmitted toward a receiving unit connected to the rechargeable battery at a certain time point according to the values received from the charger. In all embodiments described above, the charging process is performed within a safe predefined range of temperature, voltage and current so as to maintain longevity of the charged battery and avoid damage that may occur to the battery or shorten the battery. The charging process may be a wireless charging process or a non-wireless charging process.

In a further aspect, the invention is directed to a system for charging a rechargeable battery, the system comprising: a platform for holding a battery to be charged; a power source for charging said battery; a charger (PMIC) for regulating the voltage and current from the power source to the battery; a detector for determining the voltage of the battery; and an operating software for managing the charging controller;

wherein the detector determines the capacity and voltage of the battery under charge, said charger determined a minimal voltage value based on the capacity and initial charge on the battery and begins charging the battery in a pre-charging profile up to a minimal voltage value;
wherein upon said detector measures that the charge of the battery, and the charger determines based on the measured value that the battery has reached the minimal voltage value, the charger begins charging the battery in dynamic adaptive current charging profile at a maximal available current value, said dynamic adaptive current charging profile at a maximal available current is configured to allow improved charging efficiency and to minimize heat production during charging relative to constant current charging profile; and
wherein, upon said detector measures that the charge of the battery has reached a predefined voltage value, said charger begins charging the battery in a constant voltage profile up to termination of charging. In some embodiments, the charger controls the adaptive current charging profile. In some other embodiments, the charger may further communicate the measured values to a power source that controls the charging process by modifying the power level transmitted toward a receiving unit connected to the rechargeable battery at a certain time point according to the values received from the charger. The charging system may be a wireless charging system or a non-wireless charging system.

### BRIEF DESCRIPTION OF THE DRAWINGS

Examples illustrative of embodiments of the disclosure are described below with reference to figures attached hereto. Dimensions of components and features shown in the figures are generally chosen for convenience and clarity of presentation and are not necessarily shown to scale. The figures presented in the form of schematic illustrations and, as such, certain elements may be drawn greatly simplified or not-to-scale, for illustrative clarity. The figures are not intended to be production drawings. The figures (Figs.) are listed below.

FIG. 1 is a schematic illustration of standard Li-ion battery charging profile with a constant current (CC) and constant voltage (CV) phases according to the current state of the art.

FIG. 2 is a schematic illustration of wireless adaptive charging profile of Li-ion battery according to examples of the invention.

FIG. 3 is a schematic exemplary block diagram illustrating the components of a wireless charging system enabling adaptive current charging of a battery.

FIG. 4 is a schematic illustration of data flow between a charger and a power transmitting device during wireless adaptive current charging process of a LI-ion battery by RF Energy.

FIG. 5 is a schematic illustration of adaptive charging profile of Li-ion battery according to examples of the invention, wherein the power source for charging is a voltage source.

### DETAILED DESCRIPTION

In one main aspect, the present invention is aimed to provide a novel method for controlling battery charging, based on adaptive current charging profile instead of the traditional constant current charging profile of batteries, as will be described in detail below.

The present invention in another main aspect is aimed to provide a novel charger that is configured and operable to charge a battery in a dynamic adaptive charging current, wherein the charging current level in a specific time point it determined based on real time measurements of parameters indicative of the adaptive current charging progress.

In a further aspect, the invention is aimed to provide a charging system, in which a transmitting device may be passive and the charger masters the charging process, or the transmitting device may master the charging process of a battery based on real time data parameters indicative of the adaptive current charging progress being communicated to the transmitting device from a charger connected to the battery to be charged, while the charger in this embodiment is relatively passive. In all embodiments described in details below, the charger is a novel charger that is capable of charging a battery by adaptive current charging profile as will be explained in details below.

The term “charger” as used herein is directed to a charging IC also known as a “PMIC” or “charging IC” and may be used in the text interchangeable, while all terms as used herein have the same meaning of an element that is functionally connected to a battery or to a device under charge (DUC) and charge it. In accordance with embodiments of the invention, the novel charger may control the adaptive current charging phase (“master”), or it can play a passive role in the charging process (“slave”) while the power transmitting device controls the charging process based on data communicated to it in real time by the charger. The terms “power transmitting device”, “transmitter”, “energy power transmitter” may be used in the text interchangeable, while all terms as used herein have the same meaning of a wireless power source that transmit energy for charging a battery or an electronic device in a wireless manner.

The term “Battery” as used herein should be construed as covering a rechargeable battery either standing alone or implemented within an electronic device to be charged. Accordingly, the terms “Battery”, “Device under Charge”, “DUC”, “Electronic device” may be used in the text interchangeable, while all terms as used herein have the same meaning of the object to be electronically charged.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

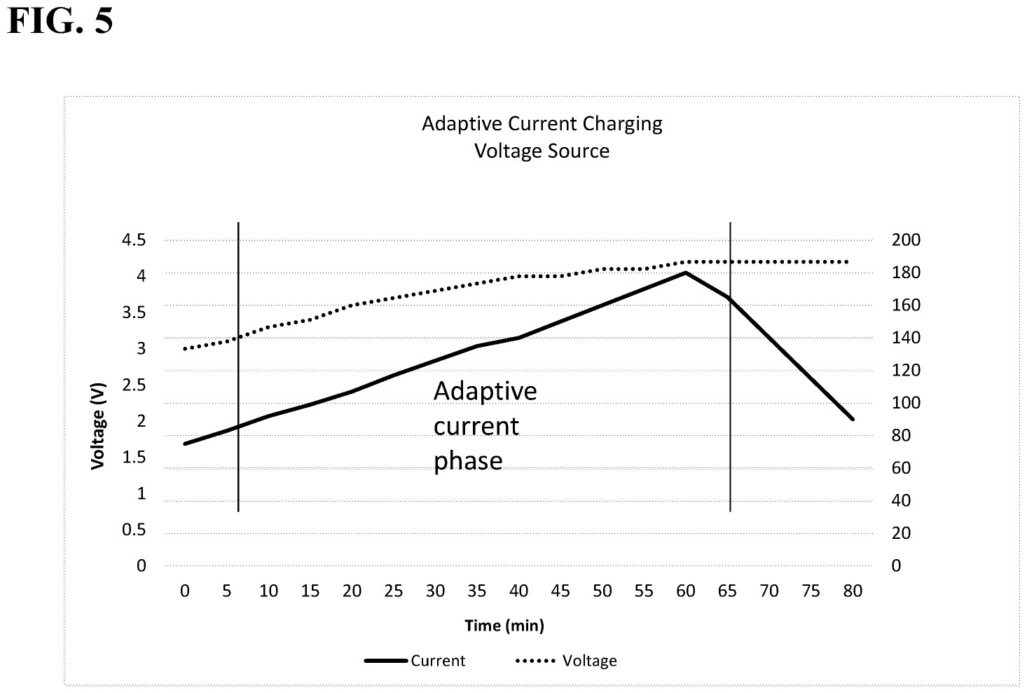

In small electronic devices such as wearable electronic devices the heat generation becomes a very important barrier. The charging method provided herein is aimed to minimize the heat production during charging, in advance, by way of changing the state of the art charging profile of batteries such that dynamic adaptive current charging profile is used, instead of constant charging process, based on real time measurements of the charging process. The method of adaptive current charging profile in accordance with embodiments of the present invention may be applied to charging process by an energy power source (i.e. wireless charging), and also mutatis mutandis to charging by a voltage source (i.e. by wire charging such as USB) as will be described in details in the example below and with reference to FIG. 5.

By using the adaptive charging method of the invention, not only that the sensitive components are protected but it further allows to increase the charging current value and consequently to shorten the charging duration if desired.

In this manner, when the charging power is a Voltage source, the charging IC will try to minimize the energy that is being turned into heat and to keep it constant. Given that the Power that transform into heat is:

Pₕₑₐₜ=(V_{source}−V_{bat})*I_{bat}

As V_{bat} increases, the charging IC will increase the current that goes into the battery (I_{bat}).

And further, when the charging power is an energy source the charging IC is configured to use adaptive current to maximize usage of the energy and to operate on constant power where possible. Given that the Power goes to the battery is:

P_{charge}=V_{bat}*I_{bat}

As the battery voltage goes up, the charging IC decreases the current to the battery in order to minimize the power variation.

These examples of implementation of this invention are further described in details hereinbelow:

### Example 1: Charging by a Voltage Source

Using voltage source such as USB is the typical case for battery charging. Referring to Li-ion battery as none limiting example, the battery charging starts at 3V and ends at 4.2V. The difference between the voltages of the source (normally 5V) and the battery voltage is translated into heat. At the regular charging method during the constant current phase a lot of heat is generated at the beginning of the charging process and less towards the end of the phase. For example assuming charging at 100 mA: at the beginning of the phase 100 mA×(5V−3V)=200 mW is transformed into heat and at the end of the phase 100 mA×(5V−4.2V)=80 mW is transformed into heat.

When using the adaptive current charging method of the present invention, the current starts lower and increases as the voltage of the battery increase. As a result the maximum dissipated as well as the overall dissipated power are much smaller than in the regular method. Table 1 below provides comparative values of dissipated power according to the current at the beginning of the CC phase and at the end of the CC phase, in the currently used constant charging method and in the novel adaptive charging method of the invention.

TABLE 1

| | Regular charging method | | | |
|---|---|---|---|---|
| | (Constant Current (CC)) | | Adaptive charging method | |
| | Current | Dissipated power | Current | Dissipated power |
| At the CC starting | 100 mA | 100*(5 − 3) = 200 mW | 80 mA | 75*(5 − 3) = 150 mW |
| point (3 V) | | | | |
| At the end of the | 100 mA | 100*(5 − 4.2) = 80 mW | 120 mA | 130*(5 − 4.2) = 104 mW |
| CC phase (4.2 V) | | | | |
| Max | | 200 mW | | 150 mW |
| Average | | 140 mW | | 127 mW |

Dissipated Power levels in regular charging method and in adaptive charging method at the beginning and at the end of the Constant current (CC) phase, when charging is performed by a Voltage charging source.

### In the Table:

Assuming charging Li-ion battery with upper charging voltage limit of 4.2V and charging is performed at a nominal current of 100 mA (the nominal current is derived from the time duration that the designer wants to charge the battery). When the charging Integrated Circuit (IC) is powered on, it starts charging the battery. If the battery is at a voltage lower than 3V it will starts charging at very low current till it reach 3V (pre charge phase).

At the adaptive phase (“constant current”) the charger IC adapts the charging current to the battery IC increase it as the battery voltage goes up, for example, it starts with 75 mA @ 3V and increase the current at 5 mA every 0.1V till it reaches 130 mA at 4.1V. At 4.2V the IC goes into constant voltage phase.

At constant voltage phase the IC is charging at 130 mA and the battery voltage is 4.2V. Every time the battery voltage increases the IC reduce the current to stabilize the battery at 4.2V. When the current reaches 10 mA the charging process stops and a battery full indication is raised.

### Example 2: Charging by an Energy Power Source

In a wireless charging process, the energy transmitted by a power transmitting device is received by a receiver of the device under charge or a receiver connected to a battery. The voltage and current values obtained from the transmitted energy depend mainly on the receiver circuitry and especially on the load that it reflects to the transmitting device.

In accordance with embodiments of the invention, in the adaptive current charging method provided herein, a charger (PMIC) at the receiving side is configured to dynamically adapt the charging current value to the available energy, for example, it may start with a certain charging current value and as long as the charging process proceed and the value of the voltage increase, the value of the charging current decreases, as the power of the battery equals the Battery Voltage multiple the Battery Current (Vbat*Ibat). Consequently, when using the adaptive current charging profile of the present invention instead of using a constant current charging profile as used in the state of the art, there is a minimal waist of current that is transformed into a heat. Thus, by eliminating the main reasons for heat production during charging, the battery longevity increases and optional damage to the battery cells as a result of overheat is diminished drastically. In other words, the heat dissipation is almost constant and much lower relative to values obtained in the regular charging methodology. In addition, the overall efficiency of the wireless charging process increases. Exemplifying values are illustrated in Table 2 below.

TABLE 2

| | Regular Charging method | | Adaptive Charging method | |
|---|---|---|---|---|
| | Power received | | | |
| | 500 Mw | | 400 Mw | |
| | Current | Dissipated power | Current | Dissipated power |
| At the CC starting | 100 mA | 100*(5 − 3) = 200 mW | 115 mA @ 3.5 V | 120*(3.5 − 3) = 60 mW |
| point (3 V) | | | | |
| At the end of the | 100 mA | 100*(5 − 4.2) = 80 mW | 85 mA @ 4.7 | 85*(4.7 − 4.2) = 42.5 mW |
| CC phase (4.2 V) | | | | |
| Max | | 200 mW | | 60 mW |
| Average | | 140 mW | | 51 mW |

Dissipated power levels in regular charging method and in adaptive charging method, at the beginning and at the end of the Constant current (CC) phase, in a wireless RF energy charging.

### In the Table:

In the regular charging method using of the shelf standard charger, the charger expect to receive 5V along the whole process, and the charging current is constant in the example above 100 mA. Charging in adaptive current charging profile is implemented for example, when targeting for a nominal current of 100 mA (the nominal current is derived from the time the designer wants to charge the battery), assuming that the voltage drop required is 0.5V. An energy power transmitter receives indications from the charger input voltage and the charging current. At the start point, assuming the charging starts at a pre-charge phase, the transmitter starts sending low energy and increase the energy until the charger charges the battery at 80 mA. As the accuracy of the transmitter is limited, assumption is made that the voltage at the PMIC input is 4.7V transmitting at 80 mA.

At the adaptive current charging phase after the energy at the input is stabilized, the charger increases the current to the battery till the voltage drops between the PMIC input and the battery voltage is 0.2V. For example, if at 115 mA the voltage is 3.2V assumption can be made that at 80 mA the voltage is 4.7V (80*4.7=115*3.2). As the battery voltage goes up the charger reduces the current until the battery voltage is reaching the 4.2V and then the charger enters into a constant voltage phase.

At a constant voltage phase the charger is charging at 90 mA, the battery voltage is 4.2V and the input voltage to the charger is 4.4V. Every time the battery voltage increases, the charger reduces the current to stabilize the battery at 4.2V and as a result the voltage at the charger input rises. The transmitter then reduces the transmitted power gradually so as to avoid the charger from getting into an over voltage state and by that to save energy. When the current reaches 10 mA the charging process stops and a battery full indication is being raised.

Reference is now made to the figures.

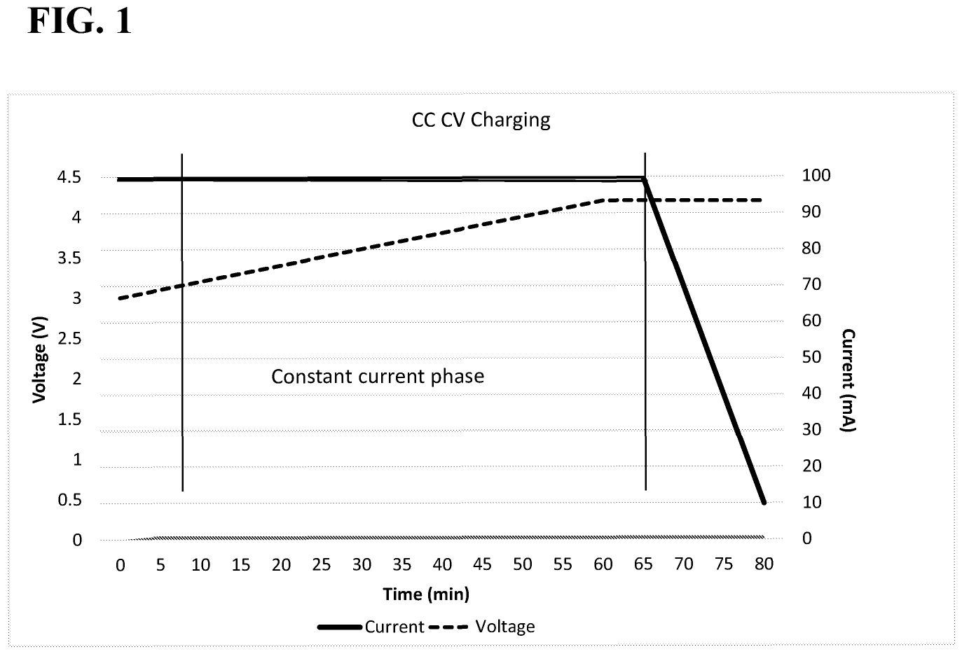

FIG. 1 is a schematic illustration of a standard Li-ion charging profile. As shown in the Figure, at the beginning of the charging process, the battery cell is charged by a constant current charge and the voltage rises. When the voltage reaches a peak, the second stage starts in which the voltage remains at the peak value and the current decreases. The charging usually terminates when the current is smaller than 3% of rated current.

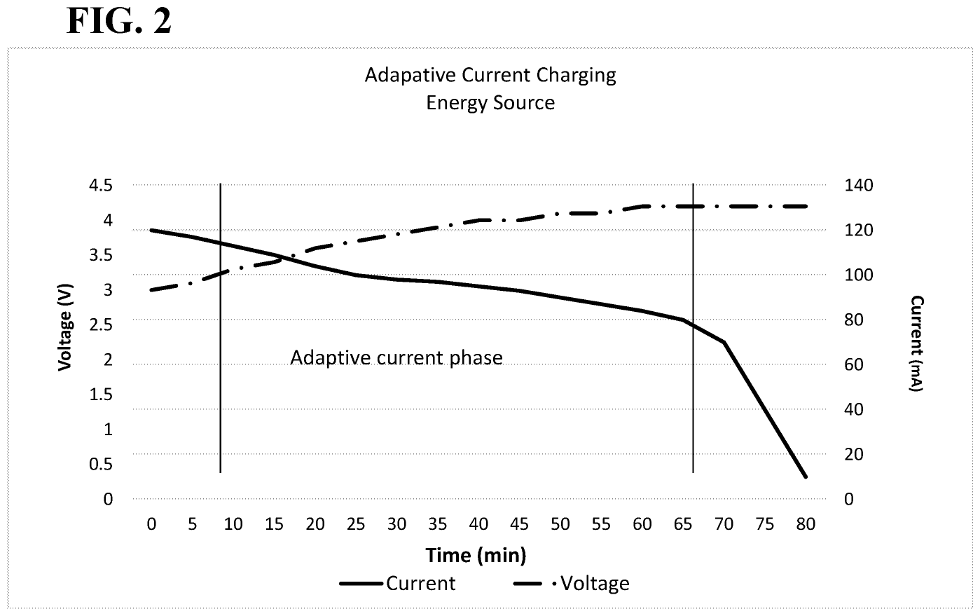

FIG. 2 is a schematic illustration of wireless adaptive charging profile of Li-ion battery according to examples of the invention. When the charging process is obtained by an energy source transmitted by a transmitting device, the receiving unit is using adaptive current to maximize usage of the energy received and to operate on constant power where possible. When the battery voltage (V_{bat}) rises, the receiving unit decreases the current to the battery (I_{bat}) in order to minimize the power (P_{charge}) variation, until reaching the constant voltage charging phase. In contrast to the constant current charging profile, the charging current values decrease during the charging process in opposite correlation to the voltage level that increases, therefore a minimal excess current is produced and therefore, the conversion of excess current into a heat as in the constant current charging profile becomes negligible.

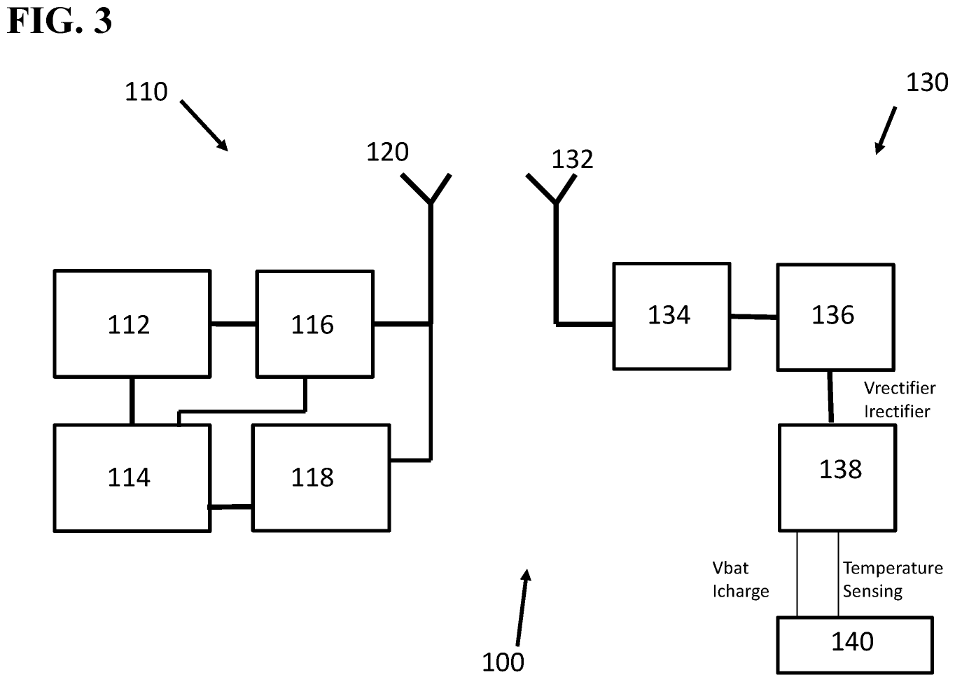

FIG. 3 is a schematic block diagram of a wireless charging system 100 configured to enable adaptive current charging of a battery. In the Example illustrated in this figure, the wireless charging system 100 comprises a transmitting device 110 that comprises at least the following components: a RF energy transmitter 112, a controller 114, communication unit 118, transmitting antenna 120, and an impedance matching network 116, preferably but not necessarily an adaptive impedance matching network. Controller 114 is configured to tune the frequency and the output power level of transmitter 112. It some embodiments, it can further tune the output power going to the transmitting antenna 120 by tuning the adaptive impedance matching network 116.

System 100 further comprises a receiving unit 130 connected to a battery, preferably of a device under charge (DUC). Receiving unit 130 comprises at least: a receiving antenna 132, an impedance matching network 134, preferably but not necessarily an adaptive impedance matching network, a rectifier 136, a charger (PMIC) 138, and a rechargeable battery 140.

In some other embodiments of the invention, communication unit 118 may communicate with a receiving unit 130 either in-band or out-of-band, and forwards the information from/to controller 114. The transmitted RF energy is capture by receiving antenna 132 and optionally transferred adaptive impedance matching network 134 to rectifier 136. Rectifier 136 converts the energy into DC energy and forwards it to the charger (PMIC) 138 that charges the battery.

Charger 138 is designed to maximize the charging current dynamically out of the received energy. In accordance with embodiments of the present invention, charger 138 may play an active role in the charging process and determine the adaptive charging current value to be used in a specific time point according to real time values of measured parameters such as battery temperature, battery surroundings temperature, battery current, battery voltage, rectifier current, and rectifier voltage, as long as the charging process is performed within a safe preprogramed range of temperature, voltage and current. In some other embodiments of the invention, charger 138 can behave as a “slave” while the energy transmitting device 110 takes control of the adaptive current charging profile based on real time measured parameters that are being communicated from the charger 138 to the transmitting device 110, In both embodiments, novel charger 138 has the capability to measure the rectifier output current (Irectifier) and output voltage (Vrectifier), the battery voltage (Vbat), the battery charging current (Icharge), and the battery/environment temperature. Charger (PMIC) 138 comprises a communication unit through which it can report in-band or out-of-band to the Wireless power transmitting device 110 on all the measured parameter.

Once the RF energy is capture by receiving antenna 132 and transferred through adaptive impedance matching network 134 to rectifier 136, the rectifier 126 converts the energy into DC energy and forwards it to charger 138. Charger 138 starts charging battery 140. As mentioned above, charger 138 has the ability to measure various parameters during charging and make use of them internally, when it controls (“Master”) the charging profile; or to communicate the measured parameters values to the power transmitting device, which controls (“Master”) the charging process in this case and the charger functions as his “slave”.

In addition, charger 138 may also communicate to the transmitting device 110 pre-configured data such as PMIC/Battery type, allowed maximal charging current per battery voltage, required average current, maximal allowed voltage, and such. Charger 138 may control the adaptive impedance matching network 134.

In accordance with embodiments of the invention, Charger 138 has limiters to maximal current per battery voltage range (for example a maximal current allowed when the batter is below 3V and maximal current allowed when the battery voltage is above 3V), and a maximal voltage limit (for example 4.2V) (limiters according to the manufactory instructions).

In accordance with embodiments of the invention there are several optional modes of operation for implementing the novel adaptive current charging profile. In all the optional action modes described hereinbelow the description is focused on the traditional constant current (CC) charging stage i.e., the main charging phase that comes after the pre-charging phase and before the constant voltage (CV) phase. The options described below substantially defer from the standard, traditional CC CV charging. In the standard charging method, the charger should be configured to charge at maximal constant current level at the CC phase and further be configured to charge at maximal voltage level as required at CV charging phase. In such configuration, as long as the wireless power transmitter transmits enough energy a CC, CV charging is maintained, and excess energy is being converted to heat in the charger and the rectifier. In some embodiment, the wireless power transmitter may optimize its output power according to the data received from the receiving unit.

### Adaptive Current Charging Profile Option 1

In accordance with this option, the charger (PMIC) connected to the battery controls the adaptive charging process (master), while the wireless power transmitter transmits a constant energy power. Wireless charging of the battery may be performed while optimizing the heat produced during the charging process and the power level that is used for charging. For this purpose, the charger should be configured to charge at maximal current available, for example, 1.2 times the average current (C) that is desired for charging the battery. Assuming most of the charging is done between 3.4V to 4.2V, the transmitter will transmit RF energy equivalent to the amount required for the receiver to charge at 0.5(3.4+4.2)×(nominal Icharge). When the charger receives the energy at the beginning of the charging (after the pre-charge phase when the battery voltage is 3.4 volt), the amount of energy 0.5(3.4+4.2)×(nominal Icharge) is bigger than 3.4×(nominal Icharge). As the charger is configured to maximize the charging current the battery will be charged at a charging rate higher than the nominal Icharge. If the transmitter keeps the transmitted energy at the same level, the charging rate will decrease as the battery voltage increases. As all the available energy will be used for charging the battery, the overall efficiency is improved, and the heat generation is minimized.

It should be noted that maximizing the current available by the charger is an ongoing process, as the charging conditions are changing along the charging process as the voltage goes up and eventually the current goes down. If at the starting point of the charging process, the battery voltage, as an example, is 3.4V and while “squeezing” the available energy the charger reach a charging current of 120 mA it is not evident that at 4.2V it can reach 97 mA (4.2×97=3.4×120) as the overall conditions are different.

### Adaptive Current Charging Profile Option 2

In accordance with this option, the control of adaptive charging phase passes to the wireless power transmitter. The charger is preferably configured to charge at maximal charging current to a limit that will be defined only as a safety level. In this option, the charging current can be manipulated by the wireless power transmitter based on data communicated reports it received from the PMIC. By controlling the transmitted energy level it will dictate the charging current. The charging profile might be also adaptive to the temperature reported by the PMIC. This feature can be used to control fast/slow charge or any other changes that one want to implement in the charging profile based new data received from users or battery manufacture or any other consideration.

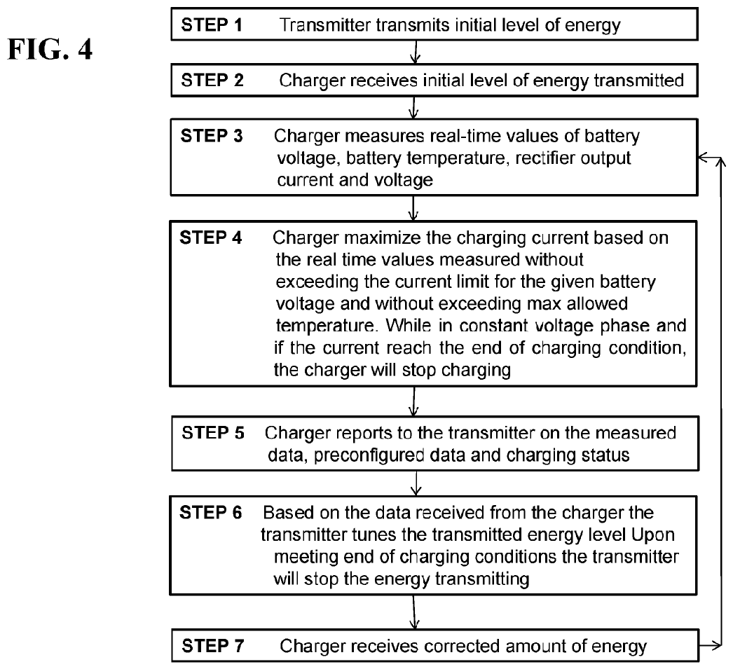

FIG. 4 is a schematic flow illustration of actions performed by a power transmitting device and a charger that is connected to a Li-ion battery and to a RF power receiver, during wireless charging adaptive current process controlled by the transmitting device.

At step 1 the transmitter sends an initial amount of energy is sufficient for the charger to operate and start charging;

At step 2 the charger turns on based on the received energy;

At step 3 the charger measures the battery voltage, the battery temperature, the rectifier output voltage, the rectifier output current. This is an ongoing activity as parameters are changing dynamically as a result of changes in the battery voltage and charging current, and at further steps as a result of changings in the energy received as a result of optimization done in step 4;

At step 4 the charger charges the battery. It constantly tries to increase the charging current and long as the charging current is below the maximal current value configured for this stage/battery voltage value, and the battery temperature is below the maximal value allowable temperature. If the maximal allowed current value is reached the process that tries to increase the current value stops. If the maximal allowed temperature is reached the charging current is being reduced until the temperature returns to a value below the maximal value allowed.

At step 5 the charger reports to the transmitter the measured parameters, the charging current and other preprogrammed data.

At step 6 the transmitter optimizes the charging process based on the data received from the charger and according to pre-programed data about the required charging profile for the specific battery/device to be charged. Optimization can be achieved by changing the matching circuit at the transmitting side, the energy frequency, etc. The transmitter can change a parameter and based on the data received from the charger, it can decide if it improving the efficiency of the charging process or not. When the control of the charging process is at the transmitter, it can allow the manufacturers to control and update the charging profile without a need to make physical changes to the battery/device under charge itself. In this operation mode, meeting the required charging profile is done mainly by increasing/decreasing the transmitted power.

At step 7 the energy is received at the charger is an ongoing process and the charger continues to maximize the charging current. The charging process will stop either by the transmitter at step 6 or by the receiver at step 4. The described process results in a charging process that minimize the energy waste that transforms into heat. Another important advantage is that due to the fact that the transmitter controls the charging process it can charge the battery at any desired profile. For example, in a scenario that after a product was launched it was found that the current charging profile allowed temperature (pre-configured at the PMIC) short the battery life, or even cause battery explosion and the charging temperature should be reduced. A small change in the configuration of the transmitter can end with the required profile to solve the problem.

FIG. 5 is a schematic illustration of adaptive charging profile of Li-ion battery according to examples of the invention, wherein the power source for charging is a Voltage source. As shown in this figure, when the charger is a voltage source, the receiver is trying to minimize the energy that is being turned into heat and keep it constant. Thus, when the voltage of the battery (V_{bat}) increases, the receiver (charging IC) increases the current that goes into the battery (I_{bat}) for keeping the energy that is being turned into heat (Pₕₑₐₜ) constant.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A method for charging a rechargeable battery, said method comprising:
a. Charging the battery in a pre-charging profile up to a minimal voltage value;
b. Charging the battery in dynamic adaptive current charging profile at a maximal available current value; and
c. Charging the battery in a constant voltage profile up to termination of charging;
wherein, said dynamic adaptive current charging profile at a maximal available current is configured to allow improved charging efficiency and to minimize heat production during charging relative to constant current charging profile.

2. The method according to claim 1, wherein said maximal available current value at the adaptive current charging profile is determined by a charger (PMIC) connected to said battery, and wherein said charger determines the maximal available current value at a specific time point based on measured parameters in real time.

3. (canceled)

4. The method according to claim 2, wherein said measured parameters are at least one of the following parameters: battery temperature, battery's surroundings temperature, battery voltage level, battery charge current, a rectifier connected to said charger voltage, and a rectifier connected to said charger current, and wherein said measured parameters are indicative of the charging level of the battery allows the charger to adjust the charging current at step (b) accordingly.

5. (canceled)

6. The method according to claim 2, wherein said measured parameters are further indicative of the safe charging range of the battery for maintaining longevity of battery.

7. The method according to claim 2, wherein said charger is configured to allow charging at maximal available charging current in real time by controlling an adaptive impedance network connected thereto and/or an internal PWM according to the at least one measured parameters.

8. The method according to claim 1 wherein said maximal available current value is the maximal current that can be obtained by a receiving unit connected to said battery from a transmitted energy, and wherein the charging process is wireless charging process.

9. The method according to claim 2, wherein said charger communicates the measured parameters values to a transmitting unit, said transmitting unit is configured to control the charging process by modifying the RF power level transmitted toward a receiving unit connected to said battery at a certain time point according to the values received from the charger.

10. The method according to claim 1, wherein said charging is performed within a safe predefined range of temperature, voltage and current so as to maintain longevity of the charged battery and avoid damage that may occur to the battery or shorten the battery.

11. (canceled)

12. A charger (PMIC) configured to charge a rechargeable battery in a dynamic adaptive current charging profile at a maximal available current value, wherein said charger is connected to a rechargeable battery and to a receiving unit having an impedance matching network, and wherein said dynamic adaptive current charging profile at a maximal available current is configured to allow improved charging efficiency and to minimize heat production during charging relative to constant current charging profile.

13. The charger according to claim 12, wherein said maximal available current value at the adaptive current charging profile is determined by the charger at a specific time point based on measured parameters in real time.

14. The charger according to claim 13, wherein said measured parameters are at least one of the following parameters: battery temperature, battery's surroundings temperature, battery voltage level, battery charge current, a rectifier connected to said charger voltage, and a rectifier connected to said charger current, and wherein said measured parameters are indicative of the charging level of the rechargeable battery and allow the charger to adjust the charging current value to minimize heat production.

15. (canceled)

16. The charger according to claim 13, wherein said measured parameters are further indicative of the safe charging range of the battery for maintaining longevity of battery.

17. The charger according to claim 13, wherein said charger is configured to allow charging at maximal available charging current in real time by controlling an adaptive impedance network connected thereto and/or an internal PWM according to the at least one measured parameters.

18. The charger according to claim 12, wherein said maximal available current value is the maximal current that can be obtained by a receiving unit connected to said rechargeable battery from a transmitted energy, and wherein the charging process is a wireless charging process.

19. The charger according to claim 13, wherein said charger communicates the measured parameters values to a transmitting unit, said transmitting unit is configured to control the charging process by modifying the power level transmitted toward a receiving unit connected to said rechargeable battery at a certain time point according to the values received from the charger.

20. The charger according to claim 12, wherein said charging is performed within a safe predefined range of temperature, voltage and current so as to maintain longevity of the charged battery and avoid damage that may occur to the battery or shorten the battery.

21. (canceled)

22. A system for charging a rechargeable battery, comprising:
a platform for holding a battery to be charged;
a power source for charging said battery;
a charger (PMIC) for regulating the voltage and current from the power source to the battery;
a detector for determining the voltage of the battery; and
an operating software for managing the charging controller;
wherein said detector determines the capacity and voltage of the battery under charge, said charger determined a minimal voltage value based on the capacity and initial charge on the battery and begins charging the battery in a pre-charging profile up to a minimal voltage value;
wherein upon said detector measures that the charge of the battery, and the charger determines based on the measured value that the battery has reached the minimal voltage value, the charger begins charging the battery in dynamic adaptive current charging profile at a maximal available current value, said dynamic adaptive current charging profile at a maximal available current is configured to allow improved charging efficiency and to minimize heat production during charging relative to constant current charging profile; and
wherein, upon said detector measures that the charge of the battery has reached a predefined voltage value, said charger begins charging the battery in a constant voltage profile up to termination of charging.

23. The system according to claim 22, wherein said charger controls the adaptive current charging profile.

24. The system according to claim 22, wherein said charger further communicates the measured values to a power source that controls the charging process by modifying the power level transmitted toward a receiving unit connected to said rechargeable battery at a certain time point according to the values received from the charger.

25. The system according to claim 22, wherein the charging process is wireless charging process.
